(19) United States
(12) Patent Application Publication
(10) Pub. No.: US 2012/0185713 A1
(43) Pub. Date: Jul. 19, 2012

(54) SERVER, STORAGE MEDIUM, AND METHOD FOR CONTROLLING SLEEP AND WAKEUP FUNCTION OF THE SERVER

(75) Inventor: LE LIN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/310,709

(22) Filed: Dec. 3, 2011

(30) Foreign Application Priority Data
Jan. 18, 2011 (CN) 201110020387.3

(51) Int. Cl. G06F 1/32

(52) U.S. Cl. 713/323

(57) ABSTRACT

In a method for controlling a sleep and wakeup function of a server, the server includes a baseboard management controller (BMC) and an operating system (OS). The method receives a sleep control command input by a user through the BMC, and controls the server to work in a sleep state according to the sleep control command. The method further receives a wakeup control command input by the user through the BMC, and controls the server to work in a wakeup state according to the wakeup control command

### BACKGROUND

1. Technical Field

The embodiments of the present disclosure relate to computing device control methods, and more particularly to a server, a storage medium, and a method for controlling a sleep and wakeup function of the server.

2. Description of Related Art

To reduce power consumption of a computing device, such as a computer, a server, or a portable terminal device, it is necessary to make the computing device enter into a sleep state when the computing device is free, and convert the sleep state into a wakeup state when the computing device is being used. However, the conversion mechanism between the sleep state and the wakeup state needs to be supported by hardware of the computing device, such as a motherboard, a network card, and a power supply, for example. It is a trouble and inefficient for the hardware to implement the conversion mechanism. Therefore, it is desirable to have a method for effectively controlling a sleep and wakeup function of the computing device.

### BRIEF DESCRIPTION OF THE DRAWINGS

FIG. 1 is a block diagram of one embodiment of a server including a state control system.

FIG. 2 is a block diagram of one embodiment of function modules of the state control system included in the server of FIG. 1.

FIG. 3 is a flowchart of one embodiment of a method for controlling a sleep and wakeup function of the server of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

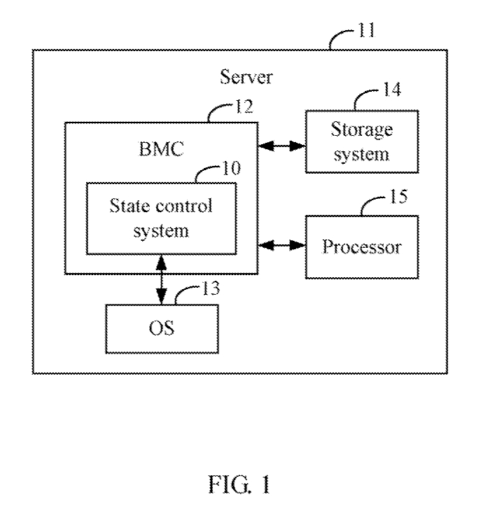

FIG. 1 is a block diagram of one embodiment of a server 11 including a state control system 10. In the embodiment, the camera device 1 may further include a baseboard management controller (BMC) 12, an operating system (OS) 13, a storage system 14, and at least one processor 15. The BMC 12 can communicate with the OS 13, the storage system 14, and the processor 15. It is understood that FIG. 1 is only one example of the server 11 that can include more or fewer components than those shown in the embodiment, or have a different configuration of the various components.

The state control system 10 may include a plurality of functional modules that are implemented by the BMC 12, and control the server 11 to control a state conversion mechanism to switch between a sleep state and a wakeup state. In the embodiment, the sleep state is defined as an operation state of the server 11 that works in a sleep mode (i.e., a low power mode), and the wakeup state is defined as an operation state of the server 11 that works a wakeup mode, i.e., a transition between the sleep mode and a working mode of the server 11.

The OS 13 may be a WINDOWS OS, a LUNIX OS, a UNIX OS or other suitable operating systems. In one embodiment, the storage system 14 may be an internal storage system, such as a random access memory (RAM) for the temporary storage of information, and/or a read only memory (ROM) for the permanent storage of information. In some embodiments, the storage system 14 may also be an external storage system, such as an external hard disk, a storage card, or a data storage medium. The processor 15 may be a central processing unit including a math co-processor, for example.

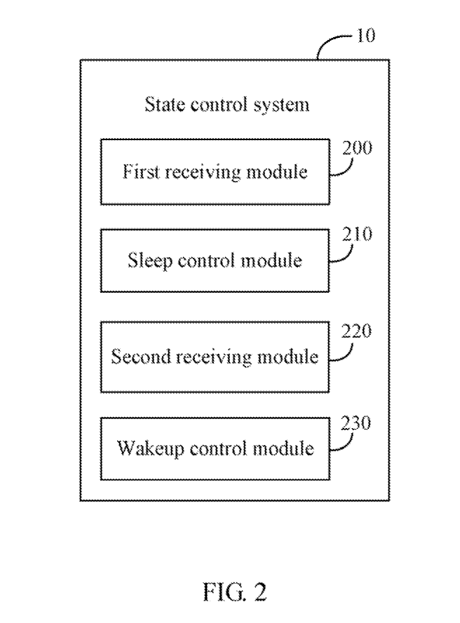

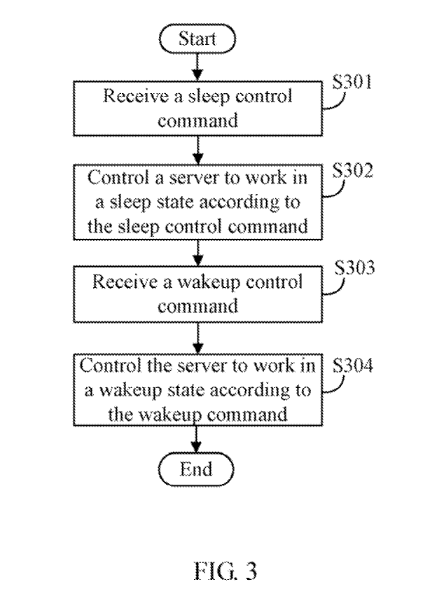

FIG. 2 is a block diagram of one embodiment of function modules of the state control system 10 included in the server 11. In the embodiment, the state control system 10 includes a first receiving module 200, a sleep control module 210, a second receiving module 220, and a wakeup control module 230. The modules 200-230 may comprise computerized instructions in the form of one or more programs that are stored in the storage system 14 and executed by the processor 15 to provide functions for implementing the modules. A detailed description of each module will be given in FIG. 3 as described in the following paragraphs.

FIG. 3 is a flowchart of one embodiment of a method for controlling a sleep and wakeup function of the server 11 of FIG. 1. In the embodiment, the method can automatically control the server 11 to make a state conversion mechanism between a sleep state and a wakeup state. Depending on the embodiment, additional blocks may be added, others removed, and the ordering of the blocks may be changed.

In block S301, the first receiving module 200 receives a sleep control command input by a user through the BMC 12. In the embodiment, the sleep control command is used to invoke the server 11 to enter into a sleep mode, and can be input by the user from the network interface or a general purpose input-output (GPIO) interface of the server 11 to the BMC 12. In one embodiment, the server 11 complies with an advance configuration and power interface (ACPI) specification or an advanced power management (APM) specification that specifies different operation states of the server 11, including the states of S0, S1, S2, S3, S4, and S5. The state S0 represents a wakeup state, each of the states S1-S4 represents a sleep state, and the state S5 represents a power-off state. For example, if the server 11 complies the ACPI specification, the server 11 may enter the sleep state S1 according to the sleep control command. If the server 11 complies the APM specification, the server 11 may enter the sleep state S4 according to the sleep control command.

In block S302, the sleep control module 210 controls the server 11 to work in the sleep state according to the sleep control command In the embodiment, the sleep control module 210 controls the server 11 to enter into a transition from the wakeup state to the sleep state when the sleep control command is received by BMC 12. In detail, the sleep control module 210 invokes a system interruption of the server 11 through the OS 13 according to the sleep command, and sets an operation mode of the server 11 to the sleep mode when the OS 13 detects the system interruption. For example, if the server 11 enters the sleep state S1, the sleep control module 210 controls the processor 15 to work in the sleep mode through the OS 13, and maintains other hardware of the server 11 to operate normally.

In block S303, the second receiving module 220 receives a wakeup control command input by the user through the BMC 12. In one embodiment, the wakeup control command is used to invoke the server 11 to work in a wakeup mode, and can be input by the user from the network interface or the GPIO interface of the server 11 to the BMC 12. For example, if the server 11 complies the ACPI specification, the server 11 may work in the sleep state S0 when the wakeup control command is received by the BMC 12.

In block S304, the wakeup control module 230 controls the server 11 to work in a wakeup state according to the wakeup control command. In the embodiment, the wakeup control module 230 controls the server 11 to enter into a transition from the sleep state to the wakeup state when the wakeup control command is received by the BMC 12. In detail, the wakeup control module 230 sends the wakeup command to the OS 13 through the BMC 12, and sets an operation mode of the server 11 to the wakeup mode when the OS 13 receives the wakeup command from the BMC 12.

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other non-transitory storage device. Some non-limiting examples of non-transitory computer-readable media include CDs, DVDs, flash memory, and hard disk drives.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A server, comprising:
a baseboard management controller (BMC) and an operating system (OS);
a storage system and at least one processor; and
one or more programs stored in the storage system and executed by the at least one processor, the one or more programs comprising:
a first receiving module operable to receive a sleep control command input by a user through the BMC;
a sleep control module operable to control the server to work in a sleep state according to the sleep control command;
a second receiving module operable to receive a wakeup control command input by the user through the BMC; and
a wakeup control module operable to control the server to work in a wakeup state according to the wakeup control command.

2. The server according to claim 1, wherein the sleep control command and the wakeup control command are input from a network interface or a general purpose input-output (GPIO) interface of the server to the BMC.

3. The server according to claim 1, wherein the sleep control module invokes a system interruption of the server using the OS when the sleep command is received by the BMC, and sets an operation mode of the server to a sleep mode when the OS detects the system interruption.

4. The server according to claim 1, wherein the wakeup control module sends the wakeup command to the OS through the BMC, and sets an operation mode of the server to a wakeup mode when the OS receives the wakeup command from the BMC.

5. The server according to claim 1, wherein the server complies with an advance configuration and power interface (ACPI) specification or an advanced power management (APM) specification that specifies the sleep state and the wakeup state.

6. A method for controlling a sleep and wakeup function of a server, the method comprising:
receiving a sleep control command input by a user through a baseboard management controller (BMC) of the server;
controlling the server to work in a sleep state according to the sleep control command;
receiving a wakeup control command input by the user through the BMC; and
controlling the server to work in a wakeup state according to the wakeup control command.

7. The method according to claim 6, wherein the sleep control command and the wakeup control command are input from a network interface or a general purpose input-output (GPIO) interface of the server to the BMC.

8. The method according to claim 6, wherein the server is controlled to work in the sleep state by steps of:
invoking a system interruption of the server using an operating system (OS) of the server when the sleep command is received by the BMC; and
setting an operation mode of the server to a sleep mode when the OS detects the system interruption.

9. The method according to claim 6, wherein the server is controlled to work in the wakeup state by steps of:
sending the wakeup command to the OS through the BMC; and
setting an operation mode of the server to a wakeup mode when the OS receives the wakeup command from the BMC.

10. The method according to claim 6, wherein the server complies with an advance configuration and power interface (ACPI) specification or an advanced power management (APM) specification that specifies the sleep state and the wakeup state.

11. A non-transitory storage medium having stored thereon instructions that, when executed by at least one processor of a server, causes the processor to perform a method for controlling a sleep and wakeup function of the server, the method comprising:
receiving a sleep control command input by a user through a baseboard management controller (BMC) of the server;
controlling the server to work in a sleep state according to the sleep control command;
receiving a wakeup control command input by the user through the BMC; and
controlling the server to work in a wakeup state according to the wakeup control command.

12. The storage medium according to claim 11, wherein the sleep control command and the wakeup control command are input from a network interface or a general purpose input-output (GPIO) interface of the server to the BMC.

13. The storage medium according to claim 11, wherein the server is controlled to work in the sleep state by steps of:
invoking a system interruption of the server using an operating system (OS) of the server when the sleep command is received by the BMC; and
setting an operation mode of the server to a sleep mode when the OS detects the system interruption.

14. The storage medium according to claim 11, wherein the server is controlled to work in the wakeup state by steps of:
sending the wakeup command to the OS through the BMC; and
setting an operation mode of the server to a wakeup mode when the OS receives the wakeup command from the BMC.

15. The storage medium according to claim 11, wherein the server complies with an advance configuration and power interface (ACPI) specification or an advanced power management (APM) specification that specifies the sleep state and the wakeup state.
